(19) United States
(12) Patent Application Publication
(10) Pub. No.: US 2009/0177659 A1
(43) Pub. Date: Jul. 9, 2009

(54) System and Method for Cyber-Expo Operating Multi-Exhibition and Managing Cumulative Data

(75) Inventors: Jong-Hyang Kim, Chungnam (KR); Surg-Won Sohn, Seoul (KR); Young-Hoon Kwon, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SIMBIO.CO., LTD, Chungnam (KR)

(21) Appl. No.: 12/278,549

(22) PCT Filed: Feb. 5, 2007
(86) PCT No.: PCT/KR07/00601

§ 371 Date: Aug. 6, 2008

(30) Foreign Application Priority Data
Feb. 7, 2006 (KR) 10-2006-0011411

(51) Int. Cl. G06F 17/30

(52) U.S. Cl. 707/9; 707/E17.032; 707/E17.005

(57) ABSTRACT

The present invention relates to a system and a method for cyber-expo operating multi-exhibition and managing cumulate data. The system for cyber-expo operating multi-exhibition and managing cumulate data comprises an exhibition material database which stores materials necessary for exhibition; a virtual space; at least one web server; a managing server; a main system. Further, in the system for cyber-expo according to the present invention, the main system selects one from a plurality of web servers, matches the exhibition material of the participant, and automatically generates the virtual exhibition space.

### TECHNICAL FIELD

The present invention relates to a system and a method for cyber-expo operating multi-exhibition and managing cumulate data, and more particularly to a system and a method for cyber-expo thereof which is allowed to hold multiple exhibitions simultaneously or many times based on subjects using the cumulative data and hold cyber-expo on three-dimensional virtual space using Flash.

### BACKGROUND ART

Due to building distribution of Information Technology Infrastructure, various living of conventional manner is changing rapidly. It is noted that on-line shopping malls are most representative, which are equal to existing off-line shops because people can compare and select various goods regardless of time and space only if they access shopping mall sites. Most enterprises have official sites which store materials and news associated with their own business. If many people want to know about any enterprise, it is common to search the official site of the enterprise. Unlike large enterprises with powerful marketing force, small and medium-sized companies and newly born companies can not appeal the product towards the mass, since promotion and marketing of the product are performed efficiently even though the product is technologically marketable to consumers. As mentioned above, it is generally known that the promotion via the official site over internet is more effective despite of low investment. In terms of the enterprises with such problems, various industry exhibitions are providing experiences through which the enterprises can exhibit and promote their own brand products. Further, the various industry exhibitions are advantageous not only for participating enterprises, but also for common consumers or enterprisers looking for cooperative companies, since exhibitions enables them to know latest information on various participating enterprises and latest technologies and trends.

### DISCLOSURE

### Technical Problem

However, even though the industry exhibitions provide many advantages for all of the participants or spectators, they have many problems. Firstly, it is followed by time and space limitation when participating or viewing the industry exhibitions. More specifically, if the location of an exhibition center is too distant to reach, the participating enterprises must take much effort and cost to move the products and workforce to the exhibition center and the spectators may have troubles to make time for viewing the exhibition due to their own business, etc. and positively does not intend to go to the exhibition center due to geographical distance. Secondly, it is not easy to participate or view all of several exhibitions which are held simultaneously. Also, the spectators have difficulties to view the exhibition again though they are concerned with subject of the exhibition due to limitation of the exhibition term. Though such problem is related to limitations of time and space similarly as the first problem, the first problem is related to limitations of time and space when holding one exhibition and the second problem is related to limitations of time and space when holding multiple exhibitions. Thirdly, because the cost to hold the industrial exhibition is too expensive, so it is difficult to hold it frequently. First of all, an organizer should prepare rental cost which is necessary to ensure enough space for exhibiting the products. Also when considering cost to make and print pamphlets, brochures and posters for promoting the industrial exhibition, delivery such promotion materials and put an advertisement in various media, it is not easy for the organizer to invest all costs.

Due to many problems mentioned above, it is difficult to hold the industrial exhibition despite of its effect. In order to overcome such problems, there are disclosed various technologies and ideas for holding and operating cyber-expo by making virtual space on internet using IT infrastructure. Actually, there have been attempts to operate an official site which provides contents associated with corresponding exhibition together while holding the exhibition. However, the conventional official site of the exhibition generally collects participants and introduces the exhibition itself, and has incomplete information on each of the participating enterprise and products. Further, though the information on enterprises and products are presented, the spectators have to communicate only in an one-directional interaction which is allowed to view only disclosed information. Most of all, according to conventional cyber-expo system and method of operating thereof, since substantial manpower and costs are necessary to make contents associated with the enterprises and the products and such contents must be used only in one corresponding exhibition, the manpower and costs are wasted severely.

Further, since single exhibition is basically held in combination with single database according to the conventional system for cyber-expo, if it is intended to hold multiple exhibitions simultaneously while managing them by means of single system, there are problems as follows: First, it is difficult to configure a plurality of programs for managing each of exhibitions, secondly it takes much cost to build equipment since large amount of database are necessary for each exhibition, and thirdly, risks of overloading the managing system is increased since single system must manage data which are carried in large amounts.

Korean Patent Application No. 10-2001-0032322 (A System for Cyber-Expo and Method of Operating thereof) discloses a system for cyber-expo which is configured with spectator/exhibitor client and server and database. The reference application can provide contents of type which the spectators want by investigating and analyzing exhibition specification and provide communication stage between the spectator and the participant if the spectator is interested in the participating product by authenticating the spectator through only email and mobile phone number. However, since only one spectator can play as like several spectators if the spectator enters fallacious information, it is difficult to trust the exhibition specification, as well as it is possible to cause the participants to be damaged as the participant can contract with the spectator who enters fallacious information. Further, in the reference application, since the information on the participating products is already saved in the database, the participant can not update the information. Of course, though it is possible to update the information in such a way that the participant informs the organizer of such circumstances and then the organizer updates it, simple correction such as, for example, misspell, lipography or mistake of editors (for example, changing of a product picture) must also go through such procedures, which is followed by inconvenience, as well as the correction contents can not be applied in real time immediately because many steps must be proceeded for one correction work.

Though Korean Patent Application No. 10-2000-0028140 (Cyber-expo Web Service Using Internet and Method of Performing thereof) and Korean Patent Application No. 10-2000-0015316 (System for Supporting Cyber Equipment Expo Using Internet) disclose ideas of cyber-expo, both of them are not different from homepage operating method. It is similar to general homepage operating method (more specifically, shopping mall or portal operating method) with regard to technology. The former is characterized in storing contents associated with promotion and investment of various companies within web server system and presenting it to the organizer, and the later is characterized in presenting 3-dimensional virtual shape of products and increasing exhibition intimacy by introducing avatar concept. However, this depends on how the contents are made, but technical meaning and value are vague.

Korean Patent Registration No. 10-0369640 (Exhibition Holding System in 3-Dimensional Virtual Reality Space and Method thereof) discloses system and method capable of holding and managing bidirectional exhibition using intelligent virtual object at 3-dimensional virtual reality space which is implemented over internet communication network. Thereby, it can address one-directional problem which is one of problems with the cyber-expo discussed above. However, skilled workers and relatively much working times are necessary to make 3-dimensional contents. Furthermore, since the reference registration is to make site for cyber-expo accordingly when single exhibition is held, like concepts of another cyber-expo discussed above, all materials must be discarded when finishing the exhibition.

All references listed above similarly compose the system for cyber-expo in concepts of single exhibition based on single system and can not hold multiple exhibition many times and simultaneously using the database with the information since it is impossible in terms of technology, cost and system load.

### Technical Solution

The present invention is contemplated in order to address problems of mentioned-above prior art and the object of it is to provide a system and a method for cyber-expo operating multi-exhibition and managing cumulate data. More particularly, the object of it is to provide a system and a method for cyber-expo thereof which is allowed to hold multi-exhibition simultaneously without large amount of memory using the cumulative data and automatically generate 2-dimensional, 2.5-dimensional, and 3-dimensional virtual space using Flash.

In order to achieve the objects, a system for cyber-expo operating multi-exhibition and managing cumulate data comprises an exhibition material database which stores materials necessary for exhibition; a virtual space database which stores objects for building virtual space; at least one web server which is connected with a plurality of clients respectively for automatically generating the virtual exhibition space added with exhibition materials conforming to the client's request using information with the exhibition material and objects being matched; a managing server which is responsible for requesting and processing to hold the exhibition and participate the exhibition; a main system which connects the at least one web server and the managing server with the exhibition material database and the virtual space database and has authentication program for authenticating an identity of participant or organizer, for processing requests by the client via the web server, searching the information conforming to the requests after accessing the database, and delivering the information searched to the client via the web server. Further, in the system for cyber-expo according to the present invention, the main system selects one from a plurality of web servers with respect to the request upon receiving requests for holding the exhibition from any client via any one of web servers connected to the main system or the managing server, matches the exhibition material of the participant searched from the exhibition material database and the object searched from the virtual space database to deliver them to the web server, and automatically generates the virtual exhibition space added with the exhibition material conforming to the request by the client using information delivered from the main system. The main system further comprise authentication program for authenticating an identity of participant or organizer.

Preferably, the web server displays the virtual exhibition space added with the exhibition material to the spectator client using Flash based plug-in and the virtual exhibition space is any one from 2-dimensional, 2.5-dimensional and 3-dimensional. The exhibition material database comprises an enterprise information item and a product information item and the virtual space database comprises an exhibition hall item, an exhibition room item, and an exhibition booth item.

Furthermore, a method for cyber-expo operating multi-exhibition and managing cumulate data comprises a) storing materials necessary for exhibition and objects for building a virtual space at an exhibition material database and a virtual space database respectively; b) receiving a request for holding the exhibition by any organizer client at a main system connected with the databases via a managing server connected with the main system; c) by the main system, delivering the objects conforming to the requests for holding the exhibition from the virtual space database to any web server of at least one web servers connected with the main system so that the virtual exhibition space is automatically generated within the web server; d) by the main system, delivering exhibition materials matched with the participant having a right to participate in the exhibition from the exhibition material database to the web server, and exhibiting the enterprise information and product information of the participant on certain area assigned within the virtual exhibition space by the web server; and e) by the web server, displaying the virtual exhibition space added with the exhibition material to the spectator client, when the web server receives a request for viewing the exhibition from any spectator client. In the displaying step d), the right to participate is offered to participants collected online or offline by the organizer. The displaying step d) further comprises f) receiving notification of participation in the exhibition from the participant client via the web server requesting to hold the exhibition; and g) inputting and storing the exhibition material by the participant client if the main system give the participant client the right to access the database, when the exhibition materials corresponding to the participant does not exist in the exhibition material database. In the displaying step e), the web server preferably displays the virtual exhibition space added with the exhibition material to the spectator client using Flash based plug-in.

### ADVANTAGEOUS EFFECTS

Hereinafter, it will be described on a system and a method for cyber-expo operating multi-exhibition and managing cumulate data referring to accompanying drawings.

FIG. 1 is a system drawing of a system for cyber-expo operating multi-exhibition and managing cumulate data according to the present invention. As shown, overall system is functionally divided into three parts, databases 110, 120 for storing materials, a main system 200 for managing and processing the materials and a managing server 300 directly connected to the main system, and web server and clients 310, 320 in charge of communication and actual interface where cyber-expo is substantially held.

The database is constructed with exhibition material database 110 and virtual space database 120. The exhibition materials, for example, an enterprise information item 111 and a product information item 112 are stored in the exhibition material database 110. The enterprise information item 111 contains general contents of enterprise name, introduction, history, investment information, article and the like, participating rights on which exhibition the enterprise is participating in at present, contents associated with the exhibition such as exhibition history of which exhibition the enterprise has ever participated in and which outcome the enterprise has achieved in past exhibitions. The product information item 112 contains contents of product characteristics, usage, performance, effect, and award-winning scores for each product, including matching index with enterprise in order to know which enterprise make the product. The enterprise information item 111 and the product information item 112 may be consisted of text information or text information with simple image information.

The virtual space database 120 stores basic objects which can make 2-dimensional/2.5-dimensional/3-dimensional virtual space. The basic objects can be classified into an exhibition hall item 121, an exhibition room item 122, and an exhibition booth item 123. The virtual space objects operates as same concept as skin. The skin refers to files such as text, graphic, video, and audio which are used for changing user screen without influencing functions at interactive web page etc. such as program, game character, web bulletin board or blog (example: Windows Media series skin change, Winamp skin change, Windows desktop change). Also using such concepts in the cyber-expo system according to the present invention, it enables the user to make a choice based on his individual taste from database of various objects. For example, in the exhibition hall item 121 is stored objects which may be used to express a form of such as building, in the exhibition room item 122 is stored objects which may be used to express various forms of such as wall surface, ceiling and floor, and in the exhibition booth item 123 is stored objects which may be used to express forms of such as small wall surface, table, rack occupying certain position inside the virtual exhibition room expressed in the exhibition room item 122.

The objects may be associated with graphic and text designated by the user or each item within the exhibition material database 110, and such association is performed by the main system 200. That is, the exhibition material database 110 and the virtual space database 120 functions to store each of the items, and the main system 200 matches and arranges the materials and delivers them to the web server 310, where the virtual space is generated.

When the web server 310 sends requests by the client 320 to the main system 200 and the main system 200 access the databases 110, 120 and sends the materials corresponding to the requests to the web server 310, the web server 310 generates the virtual space within the web server 310 using the materials to allow spectators to view it. All of organizer, participant, and spectator can access the web server 310 via the client 320. The organizer who holds the exhibition or the participant who provides materials used in the exhibition to participate the exhibition can access the databases 110, 120 through authentication of identity at the main system 200 via the web server 310, meanwhile the spectator can not directly access the main system because the only view the virtual exhibition space provided at the web server 310. The main system 200 has authentication program embedded to manage members so that the user who access the web server 310 from the client 320 may preferably be classified into organizer, participant, and spectator. The identity of the organizer/participant is authenticated at the main system 200, meanwhile the identity of the spectator is managed independently for each exhibition. Therefore, separate program for authenticating the identity of the spectator is preferably provided at each web server 310. The need to authenticate the identity of the spectator is caused to eliminate possibilities of performing fallacious meeting or contract in a case that the spectator calls the enterprise participating in the exhibition to perform meeting or contract. By the way, the spectator can range widely from common public who is interested in technology associated with subject of the cyber-expo to positive spectator who intends to acquire information on the participating enterprises and possibly associate business with any enterprise of the participating enterprises. There is nothing to worry about risk of storing fallacious information when holding/participating in the exhibition, since the information is stored in the database and thereafter costs are properly charged in consideration with usage of the database by which explicit identity may be authenticated. But, since the exhibition is focused on promoting enterprise and the associated technology rather than obtaining instant profits, it is more important that the spectators are allowed to view the exhibition without going through inconvenience procedures. Since most spectator wants to enter less detailed information even when viewing the cyber-expo after subscribing it, it is not efficient to store such information permanently on the database via the main system 200. That is, it is preferable that the member information associated with the spectator is stored in the web server 310 of each exhibition, and the organizer/participant member information is stored permanently in the database connected to the main system 200.

Though another web severs 310 serves as exhibition space where the cyber-expo is held, the managing server 300 which directly accesses the main system 200 allows the users to access the main system 200 via the client 320 and to register the organizer or the participant by submitting applications for holding the exhibition or participating in the exhibition. As discussed later, the managing server 300 and the web server 310 may perform two functions at the same time as an integrated equipment.

As an example, each function is described more specifically. First, the organizer who intends to hold the exhibition delivers a request for holding the exhibition to the managing server 300 via the client 320. Since the virtual exhibition space is not generated yet within the web server 310 where the cyber-expo is held before exhibition term, the main system 200 acknowledges the request for holding the exhibition and instructs the web server 310 to exhibit the cyber-expo, and then the web server 310 requests the main system 320 to search and deliver the object from the virtual space database 120 for generating the virtual exhibition space. For example, objects associated with building such as “future museum”, “ocean museum”, “space museum” are stored in the exhibition hall item 121 of the virtual space database 120. If the organizer selects the “future museum” via a screen shot of the exhibition hall item 121 provided by the managing server 300 and enters the materials associated with the exhibition such as exhibition title and organizer information, the managing server 300 delivers content entered by the organizer, and the main system 200 finds out the “future museum” object in the exhibition hall item 121 of the virtual space database 120, insert the exhibition materials into appropriate position as programmed, and delivers the processing result to the web server 310 where the exhibition is substantially held. Then the web server 310 generates the virtual exhibition space using materials delivered. In this example, the virtual exhibition space is generated in such a manner that the exhibition title is inserted into the building board and the organizer information is inserted into the poster in front of the building, as additional information which the organizer may insert into the basic “future museum” building. Of course, the data is programmed to be interpreted with each other, to/from which the client 320, the web server 310, the main system 200 and the virtual space database 120 can transmit/receive. At this time, it is preferable that objects used in common may use Flash Format. The Flash has advantages in that it is widely used in the web page and can express a variety of shape in relatively small file size, and more particularly it can simply distribute interpreting program as a type of browser plug-in. The objects are preferably of Flash Format due to property suitable for the cyber-expo.

If the virtual exhibition space is generated at the web server 310, the organizer accesses the web server 310 and arranges the participants within the virtual exhibition space. For example, if the organizer assigns “column 1 row F booth, 1^{st} floor exhibition room, the future museum” to “enterprise A”, the web server 310 requests the main system 200 to send information for generating the “enterprise A” booth. The main system 200 receives the requests from the web server 310, find out information on the “enterprise A” among the participants with right to participate in the exhibition from the enterprise information item 111 and the product information item 112 of the exhibition material database 110, find out the information on booth object from the exhibition booth item 123 of the virtual space database 120, and then inserts the “enterprise A” information into the booth object to deliver it to the web server 310. In other words, a banner with enterprise name of the “enterprise A” and booth internal wall with advertising poster of the “enterprise A” are generated in the “column 1 row F booth, 1^{st} floor” exhibition room within the “future museum” which is virtual exhibition space generated within the web server 310 by the operation mentioned above. The participant can confirm the “enterprise A” booth generated within the web server 320 via the client 320 and select and correct the object to be used in the “enterprise A” booth similarly as the organizer selects the object to be used in the exhibition hall and the exhibition room. When such operations are finished completing the virtual exhibition space, the spectators can view the virtual exhibition space generated within the web server 310 via the client 320.

### DESCRIPTION OF DRAWINGS

The above and other objects, features and advantages of the present invention will become apparent from the following description of preferred embodiments given in conjunction with the accompanying drawings, in which:

FIG. 1 is a drawing of a system for cyber-expo according to the present invention; and

FIG. 2 is flow diagram of a method for operating cyber-expo according to the present invention.

### DETAILED DESCRIPTION OF MAIN ELEMENTS

110: Exhibition material database
111: Enterprise information item
112: Product information item
120: Virtual space database
121: Exhibition hall item 122: Exhibition room item
123: Exhibition booth item
200: Main system 300: Managing server
310: Web server 320: Client

### BEST MODE

Hereinafter, the embodiments of the present invention will be described in detail with reference to accompanying drawings.

Since the main system 200 is responsible for accessing and processing the databases 110, 120 and the web server 310 is responsible for receiving requests to generate the virtual exhibition space from the client 320 and send answers corresponding to the requests to the client 320, a single main system 200-single web server 310 can hold a single cyber-expo or multiple cyber-expos, as well as can hold independent multiple cyber-expo simultaneously by combining a plurality of web server 310 into the single main system 200. Further, using such single main system 200-single web server 310 system can achieve advantages as follows: In the example, if the “enterprise A” participates in an exhibition A and an exhibition B simultaneously, it must deliver the enterprise information and the product information to the exhibition A and the exhibition B respectively in a case of prior cyber-expo. But according to the system according to the present invention, since each of the exhibition A and the exhibition B is held in the web server A and the web server B connected to the single main system 200, once “enterprise A” materials are stored in the exhibition material database 110, the materials can be used in the exhibition A and the exhibition B at the same time. That is, it is possible to reduce inconvenience in which the participant must deliver materials newly whenever separate exhibitions are held.

Since the web server where the exhibition is held does not exist yet when submitting applications for holding the exhibition and participating in the exhibition and the managing server 300 is necessary to access the main system 200 directly, the foregoing is described that the managing server 300 and the web server 310 are separated. Of course, one managing server 300 must exist for one main system 200. But since the managing server 300 is generally referred to web server, one web server is connected to the main system 300 so that the web server may function as the managing server 300 and the web server 310. When multiple exhibitions are held in multiple web servers 310, the managing server 300 can be responsible for requesting and processing to hold and participate in the exhibition and can provide user with a list of exhibitions which are being held by the main system 200.

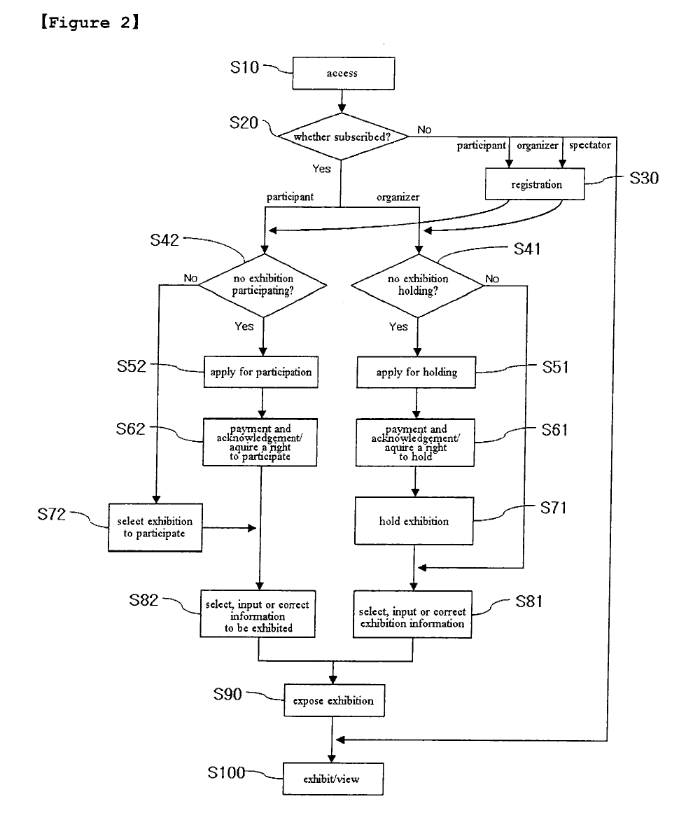

FIG. 2 is a flow diagram of a system and a method for cyber-expo operating multi-exhibition and managing cumulate data. Referring to FIG. 2, it will be described on the method of operating the system for cyber-expo according to the present invention.

First, the user can access the main system via client-managing server S10, and can confirm whether there are proceeding exhibitions at present. The main system has program embedded for authenticating the identity of member by classifying into organizer and participant, thereby determining whether the user is organizer, participant or spectator S20. If the user is not subscribed as member, the user is classified into simple spectator in order to view the exposed exhibition from list of the exhibitions which are being held by the main system S100.

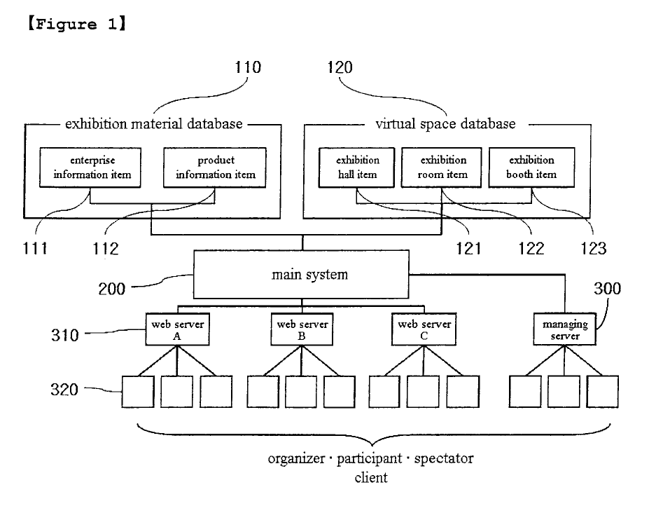

In a case of the user who holds the exhibition, if it is identified as the organizer in the determining step S20, it is determined whether there are exhibitions which the organizer is holding now S41. If there are the exhibitions which the organizer is holding now, the organizer is moved to the exhibition to access it and has a right to correct the information of the exhibition held S81. If the organizer is not holding the exhibition now, he must hold the exhibition newly and therefore the new organizer must submit an application for holding the exhibition S51. The new organizer acquires a right to hold a new exhibition to settle a corresponding cost and be certified S61, the main system makes the new organizer to hold a new exhibition with sharing a new virtual exhibition space to the new organizer S71. If a single managing server is connected to the main system so that the managing server functions as a web server where the cyber-expo is held, the organizer holds the exhibition and selects and inputs the exhibition information S81, the virtual exhibition space is generated within the managing server and web server. Or, as shown in FIG. 1, if the managing server is separated from the web server, the main system designates one web server to generate the virtual exhibition space conforming to the request for holding the exhibition, cause the new organizer to access the web server, and then cause the organizer to select and input the exhibition information S81.

In a case of user who is participating in the exhibition, if it is identified as the participant in the determining step S20, it is determined whether there are exhibitions which the participant is holding now S42. If there are the exhibitions which the organizer is holding now, the participant selects the exhibition S72, and then the participant is moved to the exhibition to access it and has the right to select and correct the enterprise information and the product information to be exhibited S82. At this time, if the participant is participating in single exhibition, the selecting step S72 is meaningless. Meanwhile, if the participant is participating in 2 or more exhibitions simultaneously, the selecting step S72 is meaning since he must select which exhibition to confirm from exhibitions which he is participating in. If there is no exhibition which the participant is participating now, he must participate in the exhibition newly, and therefore the new participant must submit an application for participating in the exhibition S52. If the participant makes a payment and is authenticated, the participant has a right to participate the exhibition. To the participant is assigned certain area within the virtual exhibition space defined by the organizer so that the participant may select, input and correct the certain area (i.e. exhibition booth with the virtual exhibition space) assigned S82. Since the enterprise information and product information of the participant are stored in the exhibition material database, the enterprise information and product information of the exhibition material database is combined with the exhibition booth object of the virtual space database to generate default in advance if the certain area is assigned to the participant. Therefore, the participant can confirm his own booth generated automatically at the same time that he acquires the right to participate in the exhibition after submitting an application for participating in the exhibition. Though the organizer can select all of the exhibition hall, the exhibition room, and the exhibition booth of the virtual exhibition space, each exhibition booth must be changed in a fashion wanted by each participant. Therefore, the organizer has the right to correct all the information of the exhibition hall, the exhibition room and the exhibition booth, meanwhile the participant has the right to correct only information of the exhibition booth which is assigned to him.

As such, if the virtual exhibition space is implemented as the cyber-expo, the cyber-expo is exposed as a web service S90 and the spectators can view such exposed cyber-expo S100.

The Individual enterprise has the right to manage the virtual exhibition booth of minimal unit from the virtual exhibition space exposed as mentioned above. Since the enterprise information and the product information are utilized cumulatively, as well as objects for generating the virtual exhibition space can be individually used for the enterprises information, the product information or current exhibition proceeding condition upon operating the system according to the present invention, the individual enterprise can maintain its own virtual exhibition booth even after finishing the exhibition. Therefore, the individual enterprise can connect the virtual exhibition booth with a separate domain to utilize it as his home page, regardless of the exhibition. The corresponding enterprise can freely make updates such as correction or change for contents of the virtual exhibition booth, participate the exhibition only by submitting the application for participating in the exhibition when other exhibition is held, and utilize his company home page by connecting it to the separate domain to expose only virtual exhibition booth independently while the exhibition is not held.

As such, it is possible to integrate work to participate in the exhibition for the purpose of promotion and marketing of the enterprise with work to operate home page used for the purpose of only promotion, and to process the renewal of the virtual exhibition booth and the update of the information using one main system. In this case, each of enterprises can save time, resource and cost which are necessary to produce their home pages and easily participate in the exhibition which is held by the main system. That is, according to the present invention, each of the enterprise does not need to deliver the information whenever the exhibition is held and convert the virtual exhibition booth into the home page while the exhibitions are not held. Also, recent cumulative information is exposed to new exhibition only by submitting the application for participating in the exhibition. Therefore, it is possible to save time, resources and cost which have been wasted due to separation of the works.

Those skilled in the art will appreciate that the conceptions and specific embodiment disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

According to the present invention, the enterprise information and the product information can be cumulated, and therefore the information stored in single database can be used in all of multiple exhibitions which are held at intervals or simultaneously. This eliminates inconvenience in that the enterprise must know various exhibitions news in order to catch opportunities of participating in the exhibition and deliver materials to each of the exhibitions respectively. Upon holding the prior cyber-expo, the organizer can hold only one exhibition through work to manufacture the site, receive the application for participating in the exhibition, and arrange material delivered by the participating enterprise. Meanwhile, using the system and the method of operating cyber-expo according to the present invention, the enterprise information and the product information are stored cumulatively and each of the enterprises can update its information page, thereby decreasing the organizer's burden on managing the information to allow the organizer to hold the exhibition easily.

Further, by allowing each of the enterprises to manage his company booth information, it is possible to convert the virtual exhibition booth into his company home page by connecting it with the separate domain while the exhibition is not held and expose the virtual exhibition booth immediately by submitting the application for participating in the exhibition without delivering the information newly when other exhibition is held. Therefore, the system and method of operating cyber-expo according to the present invention enables the enterprise to promote and market his own product only through participation in the exhibition, as well as participate in the multiple exhibitions without separate time, resource and cost and convert it into his home page usually. Therefore, it is possible to save resources and costs which have been consumed for each operation (participation in multiple exhibitions, home page management) independently.

The cumulative enterprises information and product information are text information which is very small size relatively as compared with 2-dimensional information, 3-dimensional information, and moving image information. Since each object used on exhibition screen which is automatically generated as 2-dimensional, 2.5-dimensional, and 3-dimensional is separately stored in the virtual space information database, and composed and exposed in real time in association with database of the enterprise information and product information conforming to user's requests, only basic information of each object may be stored, which results in saving the database capacity totally.

1. A system for cyber-expo operating multi-exhibition and managing cumulate data, comprising:
an exhibition material database which stores materials necessary for exhibition;
a virtual space database which stores objects for building virtual space;
at least one web server which is connected with a plurality of clients respectively for automatically generating the virtual exhibition space added with exhibition materials conforming to the client's request using information with the exhibition material and objects being matched;
a managing server which is responsible for requesting and processing to hold the exhibition and participate the exhibition;
a main system which connects the at least one web server and the managing server with the exhibition material database and the virtual space database and has authentication program for authenticating an identity of participant or organizer, for processing requests by the client via the web server, searching the information conforming to the requests after accessing the database, delivering the information searched to the client via the web server, selecting one from a plurality of web servers with respect to the request upon receiving requests for holding the exhibition from any client via the managing server, matching the exhibition material of the participant searched from the exhibition material database and the object searched from the virtual space database to deliver them to the web server.

2. The system for cyber-expo operating multi-exhibition and managing cumulate data of claim 1, wherein the web server displays the virtual exhibition space of any one from 2-dimensional, 2.5-dimensional and 3-dimensional added with the exhibition material to the spectator client using Flash based plug-in;
the exhibition material database comprises an enterprise information item and a product information item; and
the virtual space database comprises an exhibition hall item, an exhibition room item, and an exhibition booth item.

3. A method for cyber-expo operating multi-exhibition and managing cumulate data, comprising:
a) storing materials necessary for exhibition and objects for building a virtual space at an exhibition material database and a virtual space database respectively;
b) receiving a request for holding the exhibition by any organizer client at a main system connected with the databases via a managing server connected with the main system;
c) by the main system, delivering the objects conforming to the requests for holding the exhibition from the virtual space database to any web server of at least one web servers connected with the main system so that the virtual exhibition space is automatically generated within the web server;
d) by the main system, delivering exhibition materials matched with the participant having a right to participate in the exhibition from the exhibition material database to the web server, obtaining the exhibition materials comprising: d-1) receiving notification of participation in the exhibition from the participant client via the web server requesting to hold the exhibition; and d-2) inputting and storing the exhibition material by the participant client if the main system give the participant client the right to access the database, when the exhibition materials corresponding to the participant does not exist in the exhibition material database, and exhibiting the enterprise information and product information of the participant on certain area assigned within the virtual exhibition space by the web server; and
e) by the web server, displaying the virtual exhibition space added with the exhibition material to the spectator client, when the web server receives a request for viewing the exhibition from any spectator client.

4. The method for cyber-expo operating multi-exhibition and managing cumulate data of claim 3, wherein in e) displaying step, the web server is any one of 2-dimensional, 2.5-dimensional, and 3-dimensional, and displays the virtual exhibition space added with the exhibition materials to the spectator client using Flash based plug-in,
The exhibition material database comprises an enterprise information item and a product information item; and
the virtual space database comprises an exhibition hall item, an exhibition room item, and an exhibition booth item.
